(19) United States
(12) Patent Application Publication
(10) Pub. No.: US 2025/0332557 A1
(43) Pub. Date: Oct. 30, 2025

(54) MIXING AND DRINKING STRAW

(71) Applicant: Julie Sekmistrz, Rochester Hills, MI (US)

(72) Inventor: Julie Sekmistrz, Rochester Hills, MI (US)

(21) Appl. No.: 18/645,940

(22) Filed: Apr. 25, 2024

(51) Int. Cl. B01F 33/501; A47G 21/18; B01F 27/112; B01F 27/13; B01F 35/32; B01F 101/14

(52) U.S. Cl. CPC B01F 33/5011; A47G 21/18; B01F 27/112; B01F 27/13; B01F 35/32021; B01F 2101/14

(57) ABSTRACT

A drinking straw apparatus for mixing beverages and facilitating drinking beverages via suction includes a tube which is elongated between a first end and a second end and defines a channel which extends through the first end and the second end. A mixing member is coupled to the tube adjacent to the second end and extends radially outwardly from the tube. The mixing member may have a coiled wire or a plurality of radially spaced paddles, for example.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to drinking straws and more particularly pertains to a new drinking straw for mixing beverages and facilitating drinking beverages via suction.

### (2) Description of Related Art Including Information Disclosed Under 37 CFR 1.97 and 1.98

The prior art relates to drinking straws which may be used to mix, stir, or otherwise agitate beverages or other fluid mixtures. However, the prior art fails to describe such a drinking straw which has a mixing member at one end of a tube which extends radially outwardly from the tube and facilitates a mixing action. The prior art further fails to describe such a mixing member which has a helically shaped wire and such a mixing member with radially spaced paddles.

### BRIEF SUMMARY OF THE INVENTION

An embodiment of the disclosure meets the needs presented above by generally comprising a tube which is elongated between a first end and a second end and defines a channel which extends through the first end and the second end. A mixing member is coupled to the tube adjacent to the second end and extends radially outwardly from the tube.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a drinking straw apparatus according to an embodiment of the disclosure.

FIG. 2 is a bottom perspective view of an embodiment of the disclosure.

FIG. 3 is a side view of an embodiment of the disclosure.

FIG. 4 is a detail view of an embodiment of the disclosure taken from Window 4 in FIG. 3.

FIG. 5 is an in-use view of an embodiment of the disclosure.

FIG. 6 is a top perspective view of an embodiment of the disclosure.

FIG. 7 is a bottom perspective view of an embodiment of the disclosure.

### DETAILED DESCRIPTION OF THE INVENTION

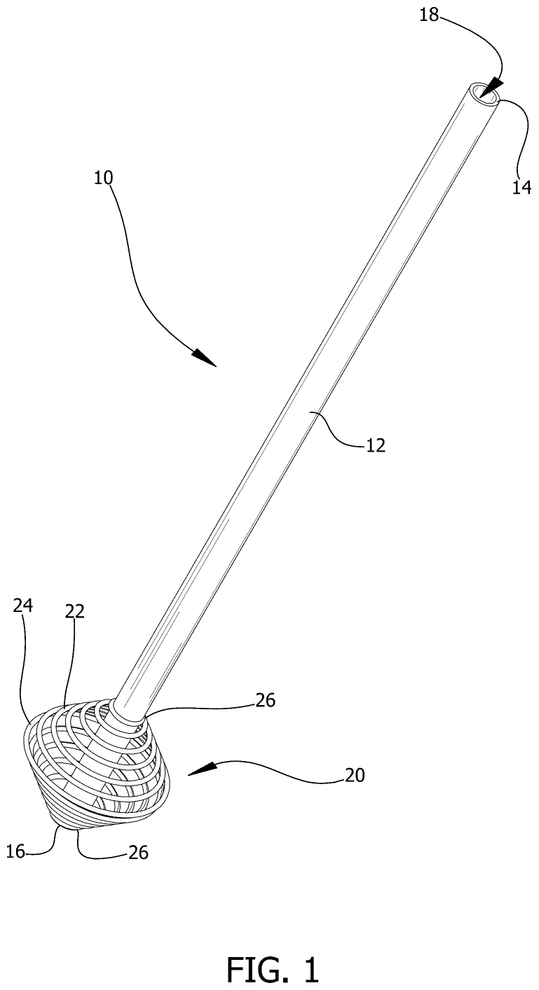

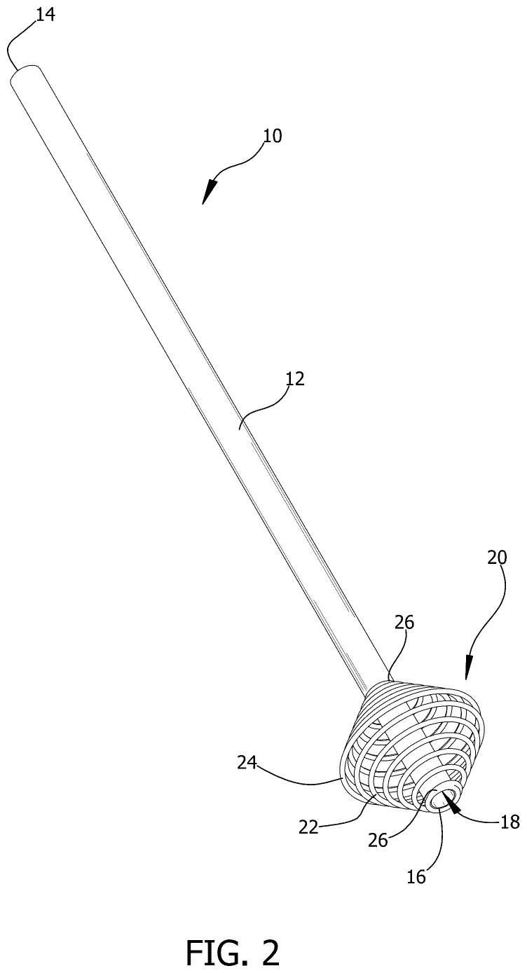

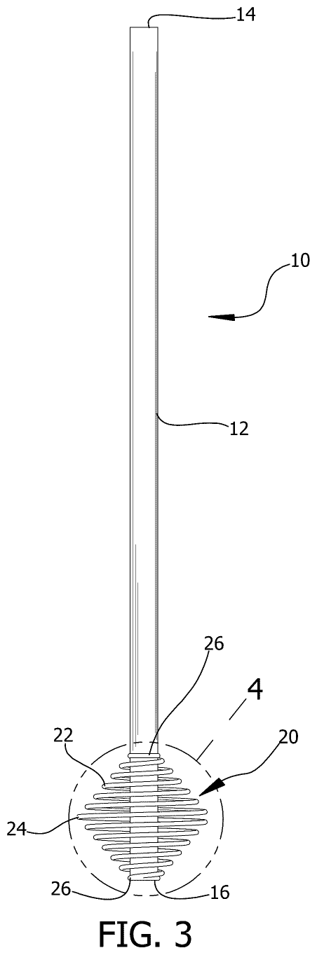

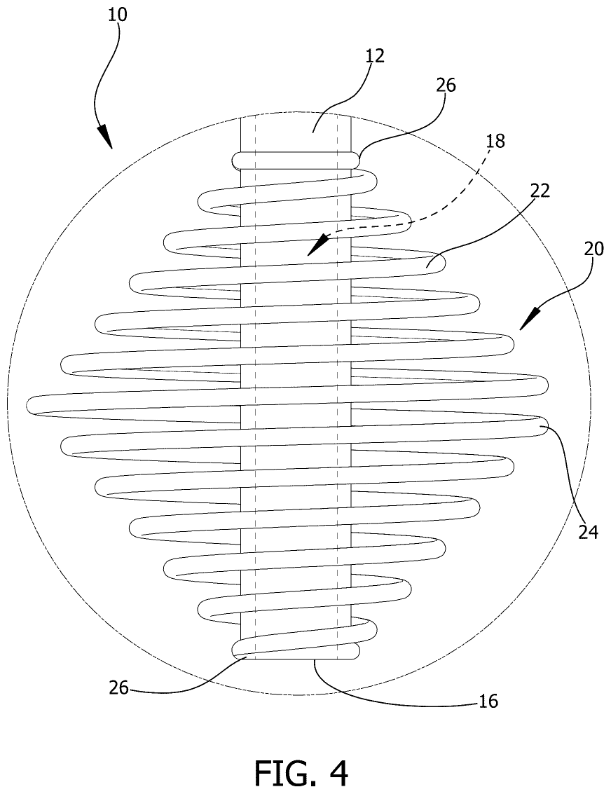

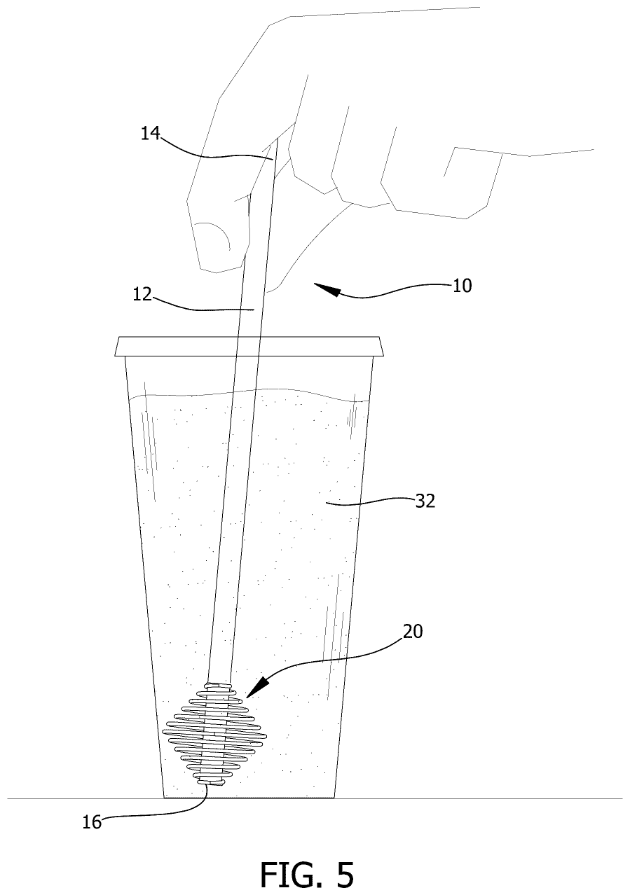

With reference now to the drawings, and in particular to FIGS. 1 through 7 thereof, a new drinking straw embodying the principles and concepts of an embodiment of the disclosure and generally designated by the reference numeral 10 will be described.

As best illustrated in FIGS. 1 through 7, the drinking straw apparatus 10 generally comprises a tube 12 which is elongated between a first end 14 and a second end 16. The tube 12 defines a channel 18 therein which extends through the first end 14 and the second end 16. A mixing member 20 is coupled to the tube 12 adjacent to the second end 16 which may be used to mix a beverage 32 or other mixture. The mixing member 20 extends radially outwardly away from the tube 12.

With reference to FIGS. 1 through 5, an embodiment of the disclosure is depicted in which the mixing member 20 comprises a wire 22 that extends circumferentially around the tube 12. The wire 22 has a helical shape that is oriented coaxially with the tube 12 and which spirals inwardly toward the tube 12 from a central portion 24 of the wire 22 to each one of a pair of ends 26 of the wire 22. Stated another way, the wire 22 extends across a boundary of a volume shaped as two cones joined at their bases such that their vertices face in opposite directions. Each end 26 of the wire 22 is positioned at an associated one of the vertices, where the wire 22 also joins to the tube 12. The portions of the wire 22 excluding the ends 26 are spaced away from the tube 12. In this manner, the wire 22 has various segments which are spaced away from the tube 12 at distances which vary from each other.

In other embodiments, the wire 22 may extend across a boundary of a volume having other shapes from the two cones described above. For example, the volume may have a spherical shape, an ovoid shape, a right cylindrical shape, or a single cone shape. In some embodiments, the mixing member 20 may have multiple wire loops which are mounted to the tube 12 and have varying diameters with respect to each other. Such wire loops may be joined to each other or to the tube 12 via additional wires or other attachment members. The wire 22 may extend along any suitable path around and spaced from the tube 12.

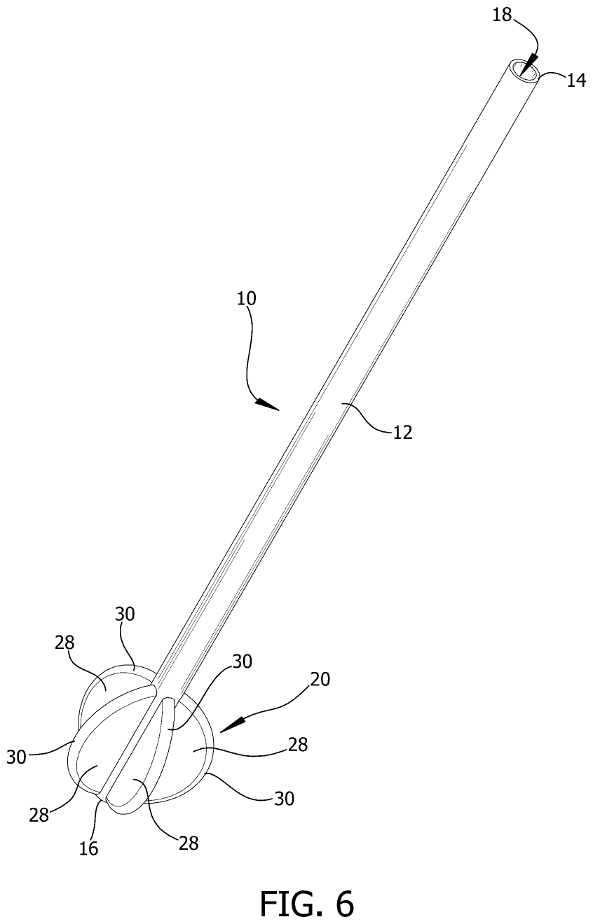

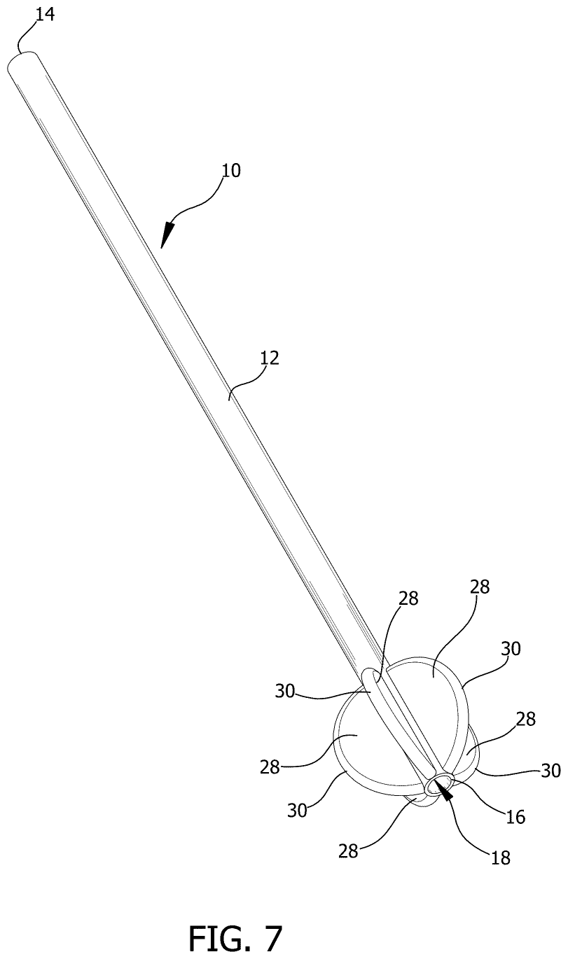

In FIGS. 6 and 7, another embodiment is shown in which the mixing member 20 comprises a plurality of paddles 28 that are radially spaced from each other around the tube 12. Each paddle 28 extends outwardly from the tube 12 to an outer edge 30 which is convex. The paddles 28 have semicircular shapes. In other embodiments, the paddles 28 may have other shapes such as rectangular shapes, triangular shapes, or any other suitable shape. The paddles 28 are integrally formed with the tube 12 but may be joined via any suitable attachment means, such as a snap connection, a latch, a force fit, or the like.

In use, the drinking straw apparatus 10 may be placed in the beverage 32 or other mixture with the second end 16 of the tube 12 submerged and the first end 14 positioned above the beverage 32. The beverage 32 may be mixed by grasping the tube 12 near the first end 14 and moving the tube 12 such that the mixing member 20 moves through the beverage 32. Suction may be applied to the first end 14 of the tube 12 in the typical manner of use for a straw to drink the beverage 32 through the tube 12.

When an embodiment such as the one shown in FIGS. 1 through 5 is used, the wire 22 moves through the beverage 32 to form a turbulent wake behind the wire 22. The turbulent wake may break up small clumps of powdered material to better mix in the powder versus a spoon or similar instrument that causes a larger current which carries the clumps of powder rather than breaking them up. The tube 12 may be moved along its axis through the beverage 32 to cause the turbulent wakes along the length of the wire 22. Notably, a typical straight stirrer straw used in this manner would not cause turbulent flows to the same extent due to the streamlined shape of the stirrer straw. An embodiment such as the one depicted in FIGS. 6 and 7 may be used by rolling the tube 12 between a user's hands or fingers to cause the paddles 28 to rotate around the tube 12, pushing the beverage 32 or other mixture outwardly in a turbulent manner.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A drinking straw apparatus comprising:
a tube, the tube being elongated between a first end and a second end, the tube defining a channel which extends through the first end and the second end; and
a mixing member coupled to the tube adjacent to the second end, the mixing member extending radially outwardly from the tube.

2. The apparatus of claim 1, wherein the mixing member comprises a wire which extends circumferentially around the tube.

3. The apparatus of claim 2, wherein the wire comprises a plurality of segments, the segments of the wire being spaced from the tube at varying distances from each other.

4. The apparatus of claim 2, wherein the wire has a helical shape which is oriented coaxially with the tube.

5. The apparatus of claim 4, wherein the wire spirals inwardly toward the tube from a central portion of the wire to each one of a pair of ends of the wire.

6. The apparatus of claim 1, wherein the mixing member comprises a plurality of paddles, the paddles being radially spaced from each other around the tube.

7. The apparatus of claim 6, wherein each paddle has an outer edge which is convex.

8. The apparatus of claim 1, wherein the mixing member is integrally formed with the tube.
